(19) United States
(12) Patent Application Publication
(10) Pub. No.: US 2014/0313910 A1
(43) Pub. Date: Oct. 23, 2014

(54) COEXISTENCE INTERFERENCE DETECTION, TRACKING, AND AVOIDANCE

(71) Applicant: Samsung Electronics Co., Ltd., Gyeonggi-do (KR)

(72) Inventor: Ian K. APPLETON, Letchworth Garden City (GB)

(73) Assignee: Samsung Electronics Co., Ltd., Gyeonggi-do (KR)

(21) Appl. No.: 13/946,491

(22) Filed: Jul. 19, 2013

Related U.S. Application Data
(60) Provisional application No. 61/813,863, filed on Apr. 19, 2013.

(51) Int. Cl. H04W 24/08

(52) U.S. Cl. CPC H04W 24/08
USPC 370/252

(57) ABSTRACT

A method of, and a wireless transceiver and/or system for, detecting coexistence interference are described. The method includes receiving, by an antenna connected to a first wireless transceiver, a wireless signal including a first signal substantially within a first frequency band from one or more first wireless transmitters; acquiring measurement α of a wideband signal, the wideband signal being a wired signal corresponding to the wireless signal received by the antenna; acquiring measurement β of a narrowband signal, the narrowband signal being the result of mixing and filtering the wideband signal; and determining, based on measurements α and β, a level of coexistence interference between the first signal and a second signal substantially within a second frequency band substantially contiguous with the first frequency band, the second signal being transmitted by one or more second wireless transmitters collocated with the first wireless transceiver.

### PRIORITY

This application claims priority under 35 U.S.C. §119(e) to U.S. Provisional Patent Application Ser. No. 61/813,863 filed on Apr. 19, 2013, the entire disclosure of which is incorporated herein by reference.

### BACKGROUND OF THE INVENTION

1. Field of the Invention

The present invention relates generally to detecting, tracking, and avoiding coexistence interference, caused by overlapping/contiguous frequency usage and/or collocation, and, more particularly, to the problem of coexistence interference between collocated Long Term Evolution (LTE) and Wireless Local Area Network (WLAN) transceivers.

2. Description of the Related Art

In the 21^{st} century, consumer electronic devices are expected to provide an ever growing array of services and capabilities. Many consumers expect their mobile phone or tablet computer to provide, e.g., Global Navigation Satellite System (GNSS) location and mapping functionality (which requires the reception of satellite signals), mobile telecommunication access (which requires radio transmission and reception to and from one or more base stations), Wireless Local Area Network (WLAN) or WiFi interconnectivity (which requires a short-range, but high throughput, wireless signal), and multiple Bluetooth connections (another short-range wireless signal). These various signals are often being transmitted and received at the same time—for example, someone sipping coffee at a diner may be talking with a friend on a cellular phone through a Bluetooth headset, mapping out her own location on the screen of the cell phone using GPS (Global Positioning System, one of the GNSS standards), and downloading a song into the cell phone from the free WiFi provided by the diner. Just in this one example, the electronic device (in this case, a cell phone) is simultaneously transmitting, receiving, and processing GPS signals, mobile telecommunications signals, Bluetooth signals, and WLAN/WiFi signals.

Each of these signal technologies was developed by a different standards group for one or more different reasons. These standards have different access mechanisms, different operating conditions, different communication schemes, different capabilities, different inputs and outputs, different peak power, etc. In the past (for the most part), there has not been a sizable inter-standard interference problem, because these different standards (and/or protocols, and/or, equivalently, technologies) operate on different frequencies. So the coffee drinker at the diner can have all of these signals being simultaneously transmitted, received, and processed on her cell phone (as long as the phone has the processing power to handle it).

However, the various communication standards continue to grow and evolve—and take up more of the wireless spectrum—while consumer electronic devices are getting smaller (and packing more capabilities in)—thus putting the transmitter/receivers (“transceivers”) and antennae of these various standards very close to one another. Under these conditions, “coexistence interference” can, and more often does, occur. “Coexistence interference” is interference between standards/protocols/technologies operating on adjacent, but typically different, frequency bands, and usually when their transceivers and antennae are operating in very close proximity. When the transceivers and antennae are packed into one device, this is called “in-device coexistence” (sometimes abbreviated IDC)—although coexistence interference also occurs between separate devices if both the frequency bands involved and the transmitting and/or receiving antennae are close enough together. This problem is also referred to in terms of “collocation” or “co-location” (meaning simply that the devices are located in the same vicinity).

For example, some components in a cell phone 100 are shown in FIG. 1. Mobile telecommunication transceiver 110 and antenna 115 operating within the Long Term Evolution (LTE) standard, GNSS (e.g., GPS) receiver 120 and antenna 125, and WLAN/Bluetooth transceiver (WLAN/BT) 130 and antenna 135 are all packed into a cell phone 100, which is a likely candidate for in-device coexistence interference. The two different WLAN and Bluetooth standards share the same transceiver and antenna in cell phone 100 because they share the same frequency band, as will be discussed below, and thus often share the same hardware—although the problems and solutions discussed herein apply regardless of whether WLAN and Bluetooth share or use different hardware, such as transceivers or antennae. Although this example has an LTE transceiver/antenna 110/115, the problems and solutions discussed herein apply regardless of the particular mobile telecommunications standard.

The other cause of coexistence interference is that the collocated antennae are using nearby, adjacent, and/or, in some cases, slightly overlapping frequency bands. FIG. 2 shows the radio spectrum from around 2300 MHz to 2700 MHz, and some of the commonly used standards/protocols that are neighbors in this part of the spectrum. FIG. 2 shows the Industrial, Scientific, and Medical (ISM) 2400-2483 MHz band (one of 12 ISM bands in the U.S.), and two of the standards that use that ISM band, Bluetooth and WLAN/WiFi. Bluetooth, which operates in the 2400-2483.5 MHz band, is well-known and ubiquitous. WLAN (which also may be referred to herein as “WiFi” and/or “WLAN/Wifi”), which operates substantially within the 2400-2500 MHz band, is defined by a variety of IEEE (Institute of Electrical and Electronic Engineers) 802.11 standards, including 802.11b, 802.11g, 802.11n, and 802.11ac, and is widely used for, e.g., Internet connectivity by providing wireless Access Points (APs) in public and commercial settings.

Also shown in FIG. 2 are four frequency bands used by the LTE telecommunications standard, as defined by 3GPP (3^{rd} Generation Partnership Project): “LTE-FDD B7” 234 is LTE Band 7, which is for transmitting FDD (Frequency Division Duplex) signals as its uplink channel on 2500-2570 MHz; “LTE-TDD B40” 232 is LTE Band 40, which is for transmitting TDD (Time Division Duplex) signals on 2300-2400 MHz for both its uplink and downlink channels; “LTE-TDD B38” 236 uses 2570-2620 MHz for both uplink and downlink; and “LTE-TDD B41” 238 uses 2496-2690 MHz for both uplink and downlink.

When the compact architecture of the mobile phone in FIG. 1 and the crowded spectrum neighborhood of FIG. 2 are combined, coexistence interference is likely to occur. In particular, when, e.g., using the closely-packed transceivers/antennae in FIG. 1, the possible situations which could lead to coexistence interference include, but are not limited to, (1) when WLAN/BT transceiver/antenna 130/135 is transmitting in the ISM band and LTE transceiver/antenna 110/115 is receiving in LTE Band 40; and (2) when LTE transceiver/antenna 110/115 is transmitting in either LTE Band 7 or LTE Band 40, and WLAN/BT transceiver/antenna 130/135 is receiving in the ISM band.

Various solutions for coexistence interference have been discussed (and some implemented), including, e.g., moving neighboring frequency bands further away from each other, multiplexing between standards (e.g., having the two neighboring standards divide the usage according to time, frequency, code, etc.), antenna power management, better filters, etc.

Each proposed solution has its advantages and disadvantages, in greater or lesser proportion, based on what part of the spectrum, what type of modulation, etc., is involved. However, moving the frequency bands further away from each other would require re-mapping the spectrum allocation scheme, which, besides requiring intensive international, inter-business, and inter-standard negotiations, may have unforeseen effects on other parts of the spectrum and the large variety of technologies, devices, and systems, that currently use, or plan to use, the ISM band. Similarly, multiplexing between neighboring standards will require at least two standards bodies to negotiate and agree on a plan to “share the real estate,” and, far more practically, will devote resources in terms of communication channels and device hardware/software to this one single coexistence interference problem. Indeed, any of these proposals will require the creation of new protocols, new communication channels, new hardware, etc., dedicated to coexistence interference.

All of the proposals involving LTE coexistence interference also require signaling between the LTE transceiver and its base station so that the base station can monitor and/or manage the coexistence interference of the LTE transceiver (adding yet another level of complexity to the mobile telecommunications network, as, e.g., the base station must do this for all the terminals currently within its cell). IEEE 802.11v, which was created for coexistence interference problems involving any of the 802.11 standards with other standards/technology, is creating a new protocol for interference reporting, monitoring, and signaling between devices.

Because the wireless spectral neighborhood is becoming more and more crowded, while electronic devices are required to perform more and more functions, thereby often requiring more and more interconnectivity with multiple standards/technologies, the problem of coexistence interference is growing. The solutions thus far considered add new signaling interfaces and protocols, use up precious communication channels and computing resources, and generally add more complexity to an already-complex inter-standard/technology communication situation.

Thus, a solution is needed for the growing coexistence interference problem(s) which, in short, does not add to the complexity of the already-complex inter-standard/technology communication situation.

### SUMMARY OF THE INVENTION

The present invention addresses at least the problems and disadvantages described above and provides at least the advantages described below. According to one aspect of the invention, the coexistence interference experienced by a wireless transceiver/antenna collocated with an antenna transmitting on a substantially contiguous frequency band may be detected and/or measured.

According to another aspect of the present invention, the coexistence interference experienced by a wireless transceiver/antenna collocated with an antenna transmitting on a substantially contiguous frequency band may be tracked over time and/or analyzed in order to find one or more patterns.

According to yet another aspect of the present invention, the coexistence interference experienced by a wireless transceiver/antenna collocated with an antenna transmitting on a substantially contiguous frequency band may be mitigated using at least one of the measured level of coexistence interference, the tracked coexistence interference over time, and the analysis of coexistence interference (including any patterns found in such analysis).

According to one embodiment of the present invention, a method for detecting coexistence interference includes receiving, by an antenna connected to a first wireless transceiver, a wireless signal, the first wireless transceiver and the connected antenna being configured to receive a first signal substantially within a first frequency band from one or more first wireless transmitters; acquiring measurement α of a wideband signal, the wideband signal being a wired signal corresponding to the wireless signal received by the antenna; acquiring measurement β of a narrowband signal, the narrowband signal being the result of mixing and filtering the wideband signal; and determining, based on measurements α and β, a level of coexistence interference between the first signal and a second signal substantially within a second frequency band substantially contiguous with the first frequency band, the second signal being transmitted by one or more second wireless transmitters collocated with the first wireless transceiver.

According to another embodiment of the present invention, a wireless transceiver includes a detector configured to receive measurement α of a wideband signal and measurement β of a narrowband signal and to out put a detection signal, the wideband signal being generated from a wireless signal received by an antenna connected to the wireless transceiver, wherein the wireless transceiver and its connected antenna are configured to receive a first signal substantially within a first frequency band from one or more first wireless transmitters, the narrowband signal being the result of mixing and filtering the wideband signal; and an analyzer configured to determine, based on the detection signal, a level of coexistence interference between the first signal and a second signal substantially within a second frequency band substantially contiguous with the first frequency band, the second signal being transmitted by one or more second wireless transmitters collocated with the wireless transceiver.

According to a further embodiment of the present invention, a wireless transceiver includes one or more processors; and at least one non-transitory computer-readable medium having program instructions recorded thereon, the program instructions configured to have a system comprising the wireless transceiver perform the steps of: generating a wideband signal from a wireless signal received by an antenna connected to the wireless transceiver, wherein the wireless transceiver and the connected antenna are configured to receive a first signal substantially within a first frequency band from one or more first wireless transmitters; acquiring measurement α of the wideband signal; acquiring measurement β of a narrowband signal, the narrowband signal being the result of mixing and filtering the wideband signal; and determining, based on measurements α and β, a level of coexistence interference between the first signal and a second signal substantially within a second frequency band substantially contiguous with the first frequency band, the second signal being transmitted by one or more second wireless transmitters collocated with the wireless transceiver.

According to a further embodiment of the present invention, a wireless transceiver includes a detector configured to receive measurement α of a wideband signal and measurement β of a narrowband signal and to output a detection signal, the wideband signal being generated from a wireless signal received by an antenna connected to the wireless transceiver, wherein the wireless transceiver and the connected antenna are configured to receive a first signal substantially within a first frequency band from one or more first wireless transmitters, the narrowband signal being the result of mixing and filtering the wideband signal; and an analyzer configured to determine, based on the detection signal, a level of coexistence interference between the first signal and a second signal substantially within a second frequency band substantially contiguous with the first frequency band, the second signal being transmitted by one or more second wireless transmitters collocated with the wireless transceiver.

According to a further embodiment of the present invention, a method of detecting coexistence interference includes receiving, by an antenna connected to a first wireless transceiver, a wireless signal, the first wireless transceiver and the connected antenna being configured to receive a first signal substantially within a first frequency band from one or more first wireless transmitters; detecting any blocking of the received wireless signal; and determining, based on the detected blocking of the received wireless signal, a level of coexistence interference between the first signal and a second signal substantially within a second frequency band substantially contiguous with the first frequency band, the second signal being transmitted by one or more second wireless transmitters collocated with the first wireless transceiver.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a simplified block diagram of the components in a mobile terminal pertinent to embodiments of the present invention;

FIG. 2 illustrates how the radio spectrum from roughly 2300 MHz to 2700 MHz is allocated amongst various communication protocols pertinent to embodiments of the present invention;

FIG. 3A is a conceptual block diagram of a device including a transceiver according to an embodiment of the present invention;

FIG. 3B is a flow chart of a method of operation of the transceiver in FIG. 3A according to an embodiment of the present invention;

FIG. 4A illustrates a system including a WLAN transceiver implemented in accordance with the embodiments of the present invention shown in FIGS. 3A-3B;

FIG. 4B illustrates a Delay Locked-Loop (DLL) 460 which can replace Timer 441 in FIG. 4A in a variation on the system including the WLAN transceiver implemented in accordance with the embodiments of the present invention shown in FIG. 3A-3B; and

FIG. 4C shows an idealized representation of the Detector output and Reference Signal that is input to DLL 460 of FIG. 4B.

### DETAILED DESCRIPTION OF EMBODIMENTS OF THE PRESENT INVENTION

Various embodiments of the present invention will be described in detail below with reference to the accompanying drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

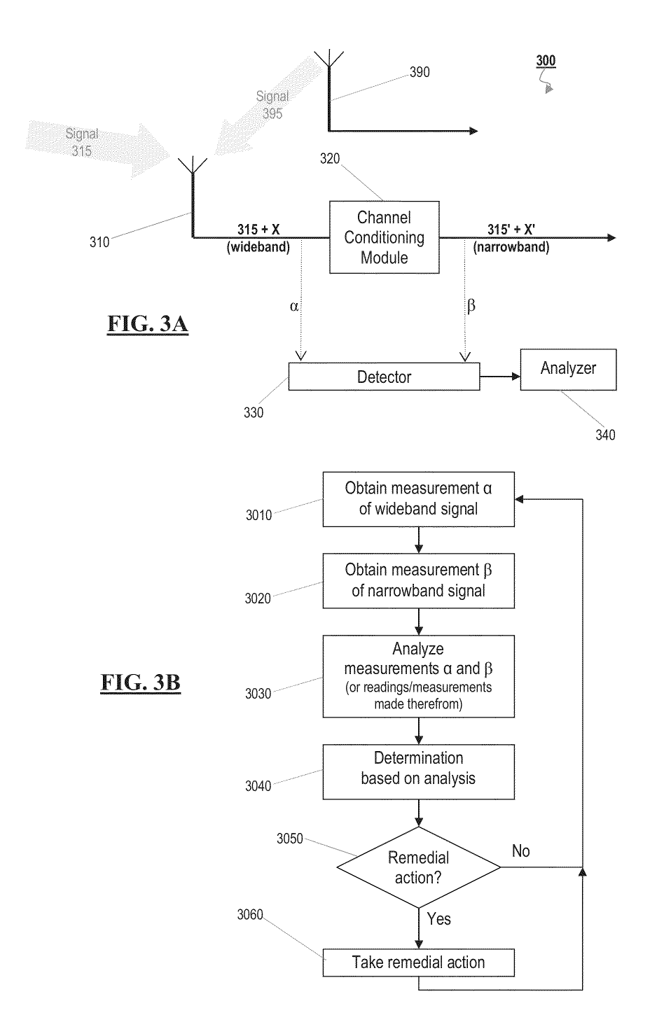

FIG. 3A is a conceptual block diagram of device 300 according to an embodiment of the present invention. In device 300, antenna 310 is configured to receive signal 315, while antenna 390, which is collocated with antenna 310 in device 300, is configured to transmit signal 395. Signals 315 and 395 may be based on different standards, may use different modulation schemes and timing, etc, but they are transmitted in frequency bands that are substantially contiguous. Herein, the term “substantially contiguous” refers to two frequency bands close enough together to cause coexistence interference under the circumstances. Thus, “substantially contiguous” may mean, e.g., the two frequency bands border each other, overlap each other, or are separated by a frequency guard band.

In FIG. 3A, antenna 310 receives both desired signal 315 and at least a portion X of signal 395 (at least enough to cause coexistence interference) as joint signal 315+X. In the reception (RX) chain of the transceiver for antenna 310, signal 315+X is processed by Channel Conditioning Module 320, which, depending on the embodiment, down-converts and/or “narrows down” signal 315+X so that it can be further processed. Although the exact details of the operation of Channel Conditioning Module 320, and how it is comprised, will vary depending on the device, the transceiver, and the standard/technology involved, for purposes of this description the pertinent feature is that joint signal 315+X enters Channel Conditioning Module 320 as a wideband signal, and leaves as narrowband signal 315′+X′.

According to this embodiment of the present invention, a Detector 330 acquires measurement α of wideband signal 315+X before Channel Conditioning Module 320 and measurement β of narrowband signal 315′+X′ after Channel Conditioning Module 320. Measurements α and β (or one or more measurements or readings derived from α and β by Detector 330) are analyzed by Analyzer 340, which determines at least one of whether there is any coexistence interference, whether coexistence interference has reached a level where it may affect performance, whether there is a pattern of coexistence interference, the pattern of coexistence interference itself, whether the pattern of coexistence interference matches a known pattern of interference (or otherwise effectively identifying the pattern of interference), the specific timing of the coexistence interference pattern, etc. When coexistence interference is found (or, e.g., exceeds a certain threshold), device 300 may take any of a number of remedial actions, some of which will be discussed in further detail below, including: changing the pattern of transmission of signal 395 or signal 315, changing the mode of operation of the transceiver for antenna 390 or antenna 310, etc.

The block diagram of FIG. 3A is “conceptual” in the sense that, although hardware is necessarily involved with all of the functions described in reference thereto, the individual functions depicted therein may be merged together and/or further separated out (by dividing a function into subfunctions), and may be performed by software, hardware, or a combination of the two. For example, Detector 330 and Analyzer 340 are depicted as separate entities, but their functions may be combined in the same piece of hardware, or partially overlap, or be implemented in the hardware of Channel Conditioning Module 320 (which Detector 330 could be, in a mobile terminal application), or, when the present invention is embodied in a software radio device, be integrated into one or more software or firmware modules. Furthermore, one or more of the components (i.e., Channel Conditioning Module 320, Detector 330, and Analyzer 340) could be duplicated in two or more transceivers in an embodiment where the signal 315 is a wideband signal received by the two or more transceivers. In such an embodiment, two or more Detector 330 signals output from the two or more transceivers could be, e.g., combined or otherwise received and analyzed by a single Analyzer 340 (or some components of Analyzer 340 could be in each transceiver, while the final analysis is performed by software in a processor in device 300 separate from the two or more transceivers).

FIG. 3B is a flowchart of a method of operation of device 300 in FIG. 3A according to an embodiment of the present invention. In step 3010, Detector 330 obtains measurement α of wideband signal 315+X, which is then processed by Channel Conditioning Module 320, which outputs narrowband signal 315′+X′. In step 3020, Detector 330 obtains measurement β of narrowband signal 315′+X′. In step 3030, Analyzer 340 analyzes measurements α and β (or one or more measurements or readings derived from α and β by Detector 330), and, in step 3040, Analyzer 340 makes a determination based on that analysis. As discussed above, the determination made by Analyzer 340 in step 3040 may be any of whether there is any coexistence interference, whether coexistence interference has reached a level where it may affect performance, whether there is a pattern of coexistence interference, the pattern of coexistence interference itself, whether the pattern of coexistence interference matches a known pattern of interference (or otherwise effectively identifying the pattern of interference), etc. Analyzer 340 may further track any of these phenomena over time, including, for example, the pattern of drift of the coexistence interference over time, the timing of the coexistence interference over time, etc.

In step 3050, it is determined whether remedial action concerning the coexistence interference should be taken. As mentioned above, the triggering criteria may be one or more events or conditions, including, without limitation, when the instantaneous level of coexistence interference reaches a predetermined threshold, a coexistence interference pattern is recognized, the average level of coexistence interference over a predetermined period of time reaches a predetermined threshold, etc. The triggering event could change depending on the status of the system.

If it is determined that remedial action should be taken in step 3050, such action is taken in step 3060. As mentioned above, remedial actions include, without limitation, changing the pattern of transmission of signal 395 or signal 315, changing the mode of operation of the transceiver for antenna 310 or antenna 390, etc. If it is determined that remedial action should not be taken in step 3050, the method returns to step 3010.

Like FIG. 3A, the method of FIG. 3B should be understood as a conceptual framework. For example, the steps do not necessarily need to occur in the order shown in FIG. 3B. In one embodiment, steps 3010, 3020, 3030, 3040, and 3050 are performed substantially simultaneously. In other embodiments, as mentioned above, the functionality of the Detector 330 and Analyzer 340 are implemented in the same hardware, software, or combination of hardware and software, and thus steps 3010-3020 and steps 3030-3050 effectively merge together in those embodiments. How and whether the detection and analysis functions are merged or separated in hardware, software, or a combination of hardware and software depends on a number of factors, as is known to one of ordinary skill in the art.

Furthermore, the implementation of the steps in FIG. 3B will vary, as would be understood by one of ordinary skill in the art, depending on the overall device or system, the specific transceivers/antennae involved, the specific standards/technologies involved, the specific intended usage of overall device/system, etc. For example, in many implementations, the steps in FIG. 3B may be implemented substantially in parallel, where certain steps are ongoing processes rather than discrete (and/or serially-performed) steps. Indeed, since many pattern-matching functionalities use iterative and/or feedback methods, embodiments using pattern-matching will indeed have the specific functionalities as discussed herein, but will only embody the “steps” of FIG. 3B in the broadest, conceptual sense, as would be understood by one of ordinary skill in the art.

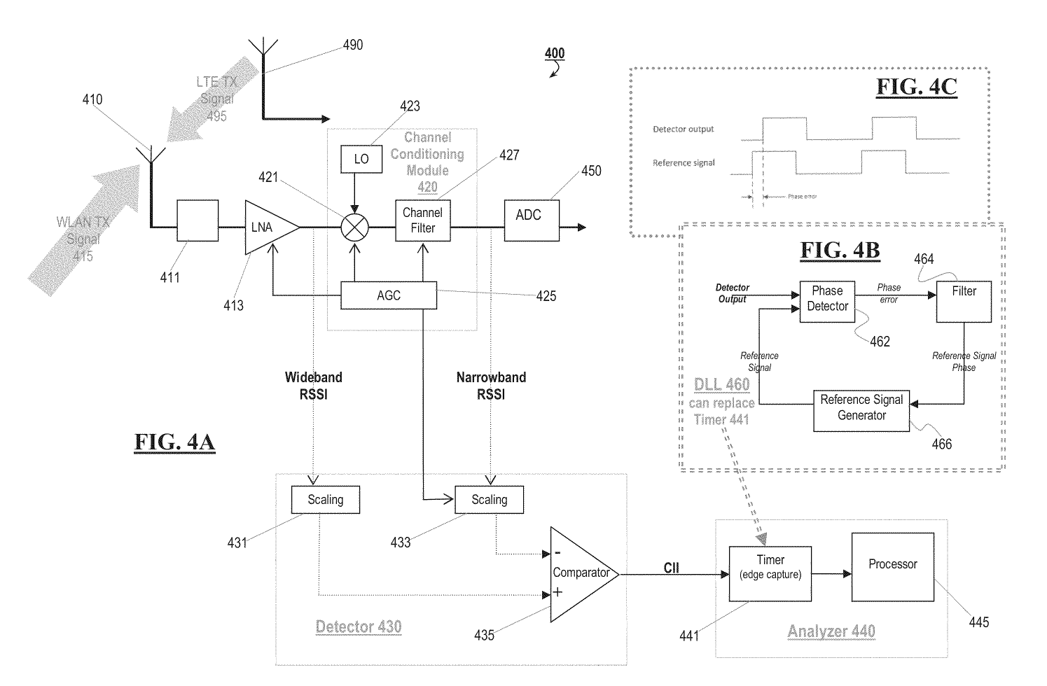

FIG. 4A illustrates a system 400 including a WLAN transceiver according to an embodiment of the present invention implemented in accordance with the conceptual block diagram shown in FIG. 3A. The WLAN transceiver receiver or reception (RX) chain shown in FIG. 4A includes antenna 410 which receives WLAN signal 415; however, WLAN antenna 410 is collocated with LTE antenna 490 which is transmitting LTE signal 495. In FIG. 4A, LTE signal 495 is being transmitted either on LTE-TDD Band 40 (2300-2400 MHz; frequency band 232 in FIG. 2) or LTE-FDD Band 7 (2500-2570 MHz; frequency band 234 in FIG. 2), which may cause coexistence interference with the lower end or upper end, respectively, of the WLAN frequency band (2401-2495 MHz; frequency band 220 in FIG. 2) in which the WLAN transceiver is receiving WLAN signal 415.

The receiver or reception (RX) chain for the WLAN transceiver in FIG. 4A operates as follows. After the signal (or “joint signal” or “signal with coexistence interference”) is received by antenna 410, it is filtered by WLAN Filter 411, whose purpose is to filter out everything outside the WLAN frequency band (this filtering function is sometimes referred to as a “mask”), and then what remains is amplified by Low Noise Amplifier (LNA) 413 for further processing. The amplified signal is then mixed in Mixer 421 with a signal from Local Oscillator (LO) 423 in order to change the frequency of the signal. This signal is then filtered by Channel Filter 427, further shaping the signal so it can be input to Analog-to-Digital Converter (ADC) 450, which then converts the analog signal to a digital signal for further processing. Automatic Gain Control (AGC) 425 monitors input/output and controls the gain of LNA 413, Mixer 421, LO 423, and Filter 427 in order to keep the power of the signal fairly steady over time.

In FIG. 4A, Mixer 421, LO 423, AGC 425, and Filter 427 perform the functions of Channel Conditioning Module 320 in FIG. 3A, and thus are included within Channel Conditioning Module 420. Of course, only the components pertinent to the explanation of this embodiment of the present invention are shown here; as is well-known to one of ordinary skill in the art, the RX chain may have additional filtering stages, gain, etc.

In this embodiment of the present invention, the Received Signal Strength Indicator (RSSI) of the wideband WLAN signal output from LNA 413 is obtained and then scaled by Scaling unit 431, while the RSSI of the narrowband WLAN signal output from Channel Filter 427 is obtained and then scaled down by Scaling unit 433 to compensate for the gain of the signal which occurs in the RX chain (in Channel Conditioning Module 420) after the wideband RSSI is measured. In essence, Scaling units 431 and 433 appropriately scale their respective input RSSI's so they can be input to Comparator 435. In this embodiment, Scaling units 431 and 433 comprise amplifiers with variable gain.

In this embodiment, the scaled wideband RSSI signal is compared to scaled narrowband RSSI in Comparator 435 to determine whether the coexistence interference has reached a level where action must be taken. In essence, the narrowband RSSI, being the negative (−) input to Comparator 435, acts as the threshold for the wideband RSSI, which is the positive (+) input to Comparator 435. As long as the scaled narrowband RSSI input is greater than or equal to the scaled wideband RSSI input, Comparator 435 outputs a logical zero signal. When the scaled wideband RSSI input exceeds the scaled narrowband RSSI input (thereby exceeding the threshold), Comparator 435 outputs a logical one signal. For the sake of brevity, this output from Comparator 435 is referred to as the CII (Coexistence Interference Indicator) signal.

Thus, in FIG. 4A, Scaling units 431 and 433 and Comparator 435 perform the functions of Detector 330 in FIG. 3A, and thus are included within Detector 430. In this embodiment, Detector 430 is implemented in hardware, but it could easily be implemented in software, since, inter alia, software is already involved in calculating the AGC values and the signal strength from the RSSI values, as is well-known to one of ordinary skill in the art. However, implementing Detector 430 in hardware allows the WLAN transceiver processor to sleep, while interference is still being listened for and detected.

The CII signal is fed to Timer 441, which helps to track characteristics of the CII over time. In this embodiment, Timer 441 performs “edge capture,” meaning it detects when the CII abruptly rises or falls, which indicates an “edge” of a signal—in this case, LTE signal 495. The timing of coexistence interference over time (as shown by edge capture) is fed to Processor 445 for further processing (which, in some embodiments, could be, e.g., de-bouncing and/or pattern detection). In this embodiment, Processor 445 is the connectivity chip of device 400, although it could be implemented in any appropriate processing element within device 400, or its functionality could be distributed among different processing elements in device 400 (or even implemented in, and/or partially distributed amongst, processing elements or systems outside of device 400). The processing elements available depend upon the specific device and/or system involved, as would be known to one of ordinary skill in the art, and, in the instance of device 400 being a mobile terminal, would include, without limitation, the connectivity chip mentioned above, one or more application processors (used to run user applications), one or more communication processors (used for communicating with cellular telecommunications networks), one or more processing elements used as part of, and/or in connection with, the reception chain of the one or more transceivers involved, etc.

In FIG. 4A, Timer 441 and Processor 445 perform the functions of Analyzer 340 in FIG. 3, and thus are included within Analyzer 440. It is noted that Comparator 435 could be considered a part of either, or both, Detector 430 and/or Analyzer 440.

An LTE transmitter 490 will typically have two effects on collocated WLAN receiver 410:
(a) desensitization due to spurious emissions received in the WLAN frequency band caused by inadequate filtering of the LTE signal; and
(b) blocking, where the presence of a relatively large out-of-band interferer causes degradation of the desired received signal due to, e.g., reciprocal mixing or AGC gain reduction.

The spurious emissions can be difficult to detect, as they are a white noise signal which raises the noise floor of the receiver. The embodiment of the present invention in FIG. 4A detects the blocking effects, as a blocker is indicated when the scaled wideband RSSI input exceeds the scaled narrowband RSSI input, thereby exceeding the threshold and causing Comparator 435 to output a logical one signal. While the blocker is outside of the desired frequency band (and hence detectable by this embodiment of the present invention), the spurious emissions are within the desired frequency band and hence relatively indistinguishable from the desired signal. However, since the relationship between spurious emissions and blocking signals is relatively predictable, one can be used as a surrogate for the other in terms of real-time analysis of channel conditions. As discussed above, the timing of the blocker can be determined using Timer 441, which captures both edges of the blocker signal. These timing values are passed to Processor 445 for further processing. As discussed above, Processor 445 may track the timing, thereby finding, for example, the pattern of drift of the coexistence interference over time, the timing of the coexistence interference over time, etc.

In a variation on this embodiment, Timer 441 is replaced by Delay-Locked Loop (DLL) 460 shown in FIG. 4B. Like most of the components discussed herein, DLL 460 may be implemented in hardware, software, or a combination of hardware and software. DLL 460 can be used to determine, for example, the timing of the CII signal, whether the CII signal matches a particular pattern, and/or how well the CII signal matches a particular pattern, as is well-known to one of ordinary skill in the art. As shown in FIG. 4B, the CII signal (“Detector output”) is input to the DLL 460's Phase Detector 462 along with a Reference signal from the Reference Signal Generator 466. A feedback loop is created by feeding the phase error output by Phase Detector 462 back into Reference Signal Generator 466 (after filtering by Filter 464). As indicated by FIG. 4C, the DLL 460 can be used to determine when, inter alia, the Detector output matches the Reference Signal. In another variation, Phase Detector 462, which ordinarily outputs a positive or negative one value, can output a zero signal when the WLAN transceiver is not receiving, and since the WLAN signal is random with respect to the LTE interference, Filter 464 should average out the interruptions in Phase Detector 462 signal.

The Reference signal used by DLL 460 can be a local timing signal (used by DLL 460 and Processor 445 to look for, and/or learn, any timing pattern), a specific known signal (or set of signals) which is/are likely to cause coexistence interference (such as an LTE-TDD Band 40 signal from antenna 490 in FIG. 4A), a pattern currently being used by another transceiver in the same device as the WLAN transceiver (provided by a back channel in system 400), etc. In other embodiments (such as implementations which analyze a set of signals), multiple DLLs can be used, operating in parallel or using sequential processing. Processor 445 may be configured to change the pattern, i.e., change the type of coexistence interference being looked for, based on the status of the WLAN transceiver and/or one or more other components in the system 400 the WLAN transceiver is in. As mentioned above, Processor 445 may adaptively “learn” coexistence interference patterns that happen over time to the WLAN transceiver. In such an embodiment, components in system 400 informed by, and/or controlled by, Processor 445 may proactively prevent coexistence interference, and/or much more quickly detect when a coexistence interference pattern has started.

Although the wideband measurement α and narrowband measurement β of the embodiment in FIGS. 4A-4C are RSSI measurements, embodiments of the present invention cover any measurement and/or analysis which would be indicative of coexistence interference. Furthermore, the RSSI measurements could be replaced by a function of the AGC settings, which in turn are a function of the wide-band and narrowband RSSI. In other words, since the AGC is continually measuring and monitoring the signal level at various points along the reception chain, the AGC's pattern of gain settings could be used in another embodiment as an indicator of a blocking signal.

In order to illustrate how embodiments of the present invention will work in general, some specific instances of coexistence interference caused by LTE antenna 490 transmitting LTE signal 495 while the WLAN transceiver is trying to receive WLAN signal 415 in the embodiment of the present invention shown in FIG. 4A will be discussed below:
LTE-TDD mode: unlike FDD, which has separate frequency bands for uplink and downlink, the LTE-TDD uplink and downlink channels share the same frequency band, but divide up uplink and downlink usage by time. LTE-TDD has 7 different patterns (“subframe allocation configurations”) for dividing up the 10 subframes in a frame: the UL usage can range from only 1 subframe out of ten, to 5 out of ten—thus, when LTE antenna 490 is using LTE-TDD Bands 38, 40, and 41 (236, 238, and 232 in FIG. 2), it will only be transmitting (and causing coexistence interference) in those 1 to 5 subframes per frame.
   In the specific implementation shown in FIGS. 4A and 4B, Analyzer 440, using DLL 460, (1) can identify the LTE-TDD pattern causing coexistence interference “in the blind,” so to speak, by searching for any pattern using the appropriate timing clock; (2) can be informed, through in-device signaling, that an LTE mode is being used, and thereby search more specifically for any LTE patterns (whether FDD or TDD); (3) can be informed, through in-device signaling, that LTE-TDD is being used, and thus search only for the one of 7 possible patterns being used; and/or (4) can be informed which specific LTE-TDD pattern is being used, and thereby determine the exact interference pattern very quickly. This, of course, is not a limiting list, but merely intended to give examples; the other possible implementations, and the possible variations on these given examples, would be well-known to one of ordinary skill in the art.
LTE-FDD mode/Voice over LTE (VoLTE): VoLTE is an implementation of voice service as data flows over the LTE data bearer—it requires nothing from legacy circuit-switched voice service implementations. VoLTE uses Semi-Persistent Scheduling of the LTE transmitter, which results in a periodic pattern.
   Thus, when LTE antenna 490 is using LTE-FDD Band 7 (234 in FIG. 2), Analyzer 440, using DLL 460, in FIGS. 4A and 4B, (1) can identify the VoLTE coexistence interference pattern “in the blind” by searching for any pattern using the appropriate timing clock; and/or (2) can be informed, through in-device signaling, that VoLTE mode is being used, and thereby search more specifically for the VoLTE pattern. This, of course, is not a limiting list, but merely intended to give examples; the other possible implementations, and the possible variations on these given examples, would be well-known to one of ordinary skill in the art.
Discontinuous reception (DRX): DRX is a specific LTE mode which provides for periods of LTE (transmission) inactivity between the network (e-UTRAN) and a terminal (UE). DRX mode may be requested by either the e-UTRAN or the UE for many different reasons, including, e.g., to save UE power, or to prevent coexistence interference between LTE and other standards/technologies, such as WLAN/WiFi or Bluetooth.
   If LTE antenna 490 enters DRX mode, Analyzer 440, using DLL 460, in FIGS. 4A and 4B, (1) can identify the DRX inactivity pattern “in the blind” by searching for any pattern using the appropriate timing clock; (2) could be informed, through in-device signaling, that DRX mode is being used, and thereby search more specifically for a DRX activity/inactivity pattern; and/or (3) could be informed, through in-device signaling, which DRX activity/inactivity is being used, and thereby search more specifically for the specific DRX activity/inactivity pattern. This, of course, is not a limiting list, but merely intended to give examples; the other possible implementations, and the possible variations on these given examples, would be well-known to one of ordinary skill in the art.
HARQ process reservation: similar to DRX mode, HARQ process reservation is also an LTE mode which provides for periods of LTE (transmission) inactivity between the e-UTRAN and the UE. Specifically, HARQ process reservation has different “bitmaps” indicating which of the ten subframes in a frame are designated to have no transmission. One possible reason for having HARQ process reservation is to prevent coexistence interference between LTE and other standards/technologies, such as WLAN/WiFi or Bluetooth.
   If LTE antenna 490 enters HARQ process reservation mode, Analyzer 440, using DLL 460, in FIGS. 4A and 4B, (1) could identify a HARQ process reservation inactivity/activity pattern “in the blind” by searching for any pattern using the appropriate timing clock; (2) could be informed, through in-device signaling, that HARQ process reservation mode is being used, and thereby search more specifically for a HARQ process reservation activity/inactivity pattern; and/or (3) could be informed, through in-device signaling, which HARQ process reservation activity/inactivity is being used, and thereby search more specifically for the specific HARQ process reservation process activity/inactivity pattern. This, of course, is not a limiting list, but merely intended to give examples; the other possible implementations, and the possible variations on these given examples, would be well-known to one of ordinary skill in the art.

Of course, the discussion above considers the specific implementation involving coexistence interference caused by LTE transmissions while a WLAN transceiver is trying to receive WLAN transmissions in and around the 2400-2483 MHz ISM band. The present invention is not limited to such, and may be used in any situation involving coexistence interference.

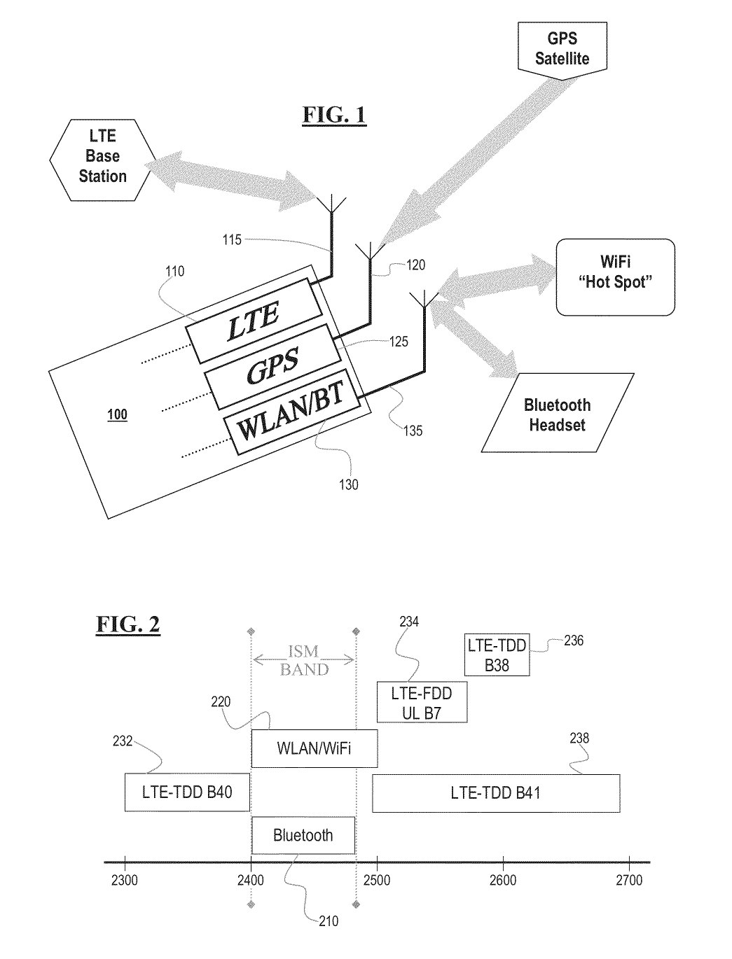

For example, returning to cell phone 100 in FIG. 1, other embodiments of the present invention could be implemented in cell phone 100 for other types of coexistence interference, such as:
VoIP+BT: the user of cell phone 100 is using a Bluetooth (BT) headset to have a “telephone conversation” where the mobile telecommunications system (i.e., LTE transceiver/antenna 110/115) is using Voice over Internet Protocol (VoIP) on one of the LTE channels substantially contiguous with the Bluetooth (BT) frequency band. Thus, in this example, both LTE transceiver/antenna 110/115 and WLAN/BT transceiver/antenna 130/135 are being used for the same voice signals in the same conversation while using substantially contiguous frequency bands and collocated antennae. Embodiments of the present invention could be implemented in LTE transceiver/antenna 110/115 and/or WLAN/BT transceiver/antenna 130/135 for detecting the BT and/or LTE/VoLTE coexistence interference pattern, respectively.
Multimedia streaming+BT: somewhat similar to the first example, except potentially involving much larger transfers of data, in this example the user is watching a High

Definition (HD) video (e.g., a movie) on cell phone 100 while listening to the stereo soundtrack of the video through Bluetooth (BT) headphones. In this example, the timing of the audio track must match the video being displayed. Also in this example, both LTE transceiver/antenna 110/115 and WLAN/BT transceiver/antenna 130/135 are being used; however, LTE transceiver/antenna 110/115 is receiving all of the data required to reproduce the HD video, while WLAN/BT transceiver/antenna 130/135 is only transmitting the audio signals to the BT headphones. In this instance, embodiments of the present invention could be implemented in LTE transceiver/antenna 110/115 and/or WLAN/BT transceiver/antenna 130/135 for detecting the BT and/or LTE coexistence interference pattern, respectively.
LTE+WLAN Tethering: “Tethering” refers to when a mobile telecommunications terminal acts as an Access Point (AP) for nearby devices to get on the Internet (using the mobile telecommunications network). In this example, the user of cell phone 100 is sitting with another person who is accessing the Internet on his tablet computer using a free WiFi service. If the free WiFi router stops working, and the Internet connection is lost, cell phone 11 can be used as a wireless AP (providing Internet connectivity through the mobile telecommunications network), thereby allowing the person with the tablet computer to get on the Internet. Thus, in this example, cell phone 100 is acting as a WLAN router for the tablet. Also in this example, both LTE transceiver/antenna 110/115 and WLAN/BT transceiver/antenna 130/135 are being used to transmit the same Internet traffic going to and from the tablet. This, of course, does not include any possible use the user of cell phone 100 may require of the terminal (such as, e.g., an incoming call on LTE-TDD Band 40 or 41). In this instance, embodiments of the present invention could be implemented in LTE transceiver/antenna 110/115 and/or WLAN/BT transceiver/antenna 130/135 for detecting the WLAN and/or LTE coexistence interference pattern, respectively.
LTE+WLAN offload: “Offloading” refers to when a mobile telecommunications terminal detects a WLAN AP nearby, and switches to using the WLAN AP for any Internet traffic (rather than using, e.g., the mobile telecommunications network). If the user is checking email on cell phone 100 and cell phone 100 detects a nearby WLAN/WiFi service, cell phone 100 switches from using the mobile telecommunications network for downloading/accessing the email account, to using the WLAN/WiFi router for downloading/accessing the email account through the Internet. If, while downloading a sizable email attachment (e.g., an HD video) and typing a reply to another email, a call comes through on one of LTE Bands 7, 40, or 41, which the user answers with the Bluetooth headset, LTE transceiver/antenna 110/115 is being used for the telephone call on one of LTE Bands 7, 40, or 41, while WLAN/BT transceiver/antenna 130/135 is doing double duty, both providing the Bluetooth headset link for the telephone call and providing the Internet connectivity with the WLAN router for the email traffic. In this instance, embodiments of the present invention could be implemented in LTE transceiver/antenna 110/115 and/or WLAN/BT transceiver/antenna 130/135 for detecting the WLAN and/or BT coexistence interference pattern and/or the LTE coexistence interference pattern, respectively.

As with all of the examples and embodiments discussed in the present application, the different examples offered above are non-limiting to the scope of the present invention(s) as recited in the appended claims. Thus, although coexistence interference between WLAN (and/or Bluetooth) and LTE has been the focus of some of the examples and embodiments discussed herein, embodiments of the present invention may be equally applied to any standards/technologies using the ISM band and/or any other mobile telecommunication standards/technologies using one or more substantially contiguous frequency bands. Furthermore, embodiments of the present invention can be applied to standards/technologies using other frequency bands. For example, embodiments of the present invention can be used for sub-1 GHz ISM band standards/technologies, such as IEEE 802.112af and 802.11ah, when there are coexistence issues with digital TV, radio microphones, etc., as well as for higher GHz ISM bands, such as the 5 GHz ISM band where there can be interference problems involving, e.g., radar. Moreover, embodiments of the present invention could be applied where harmonic resonance, rather than direct transmission on a substantially contiguous frequency band, is causing coexistence interference.

In this regard, it should be emphasized that FIG. 2 only shows two of the standards/technologies that use the ISM band, WLAN and Bluetooth, and one mobile telecommunications standard that is substantially contiguous with the ISM band, LTE—there are countless other present and future standards/technologies that use (or will use) frequency bands in, bordering, overlapping, and/or nearby the ISM band. For example, there are other international standards, such as the WiMax standard (based on IEEE 802.16), the developing IEEE 802.15.4 standard, and the Worldwide Digital Cordless Telecommunications (WDCT) standard, that use or border the ISM band. Moreover, a non-limiting list of ISM band usage examples includes, e.g., radar, sensors, RFID systems, control of public lighting systems, and remote control of toys. A non-limiting list of examples of other cellular and mobile telecommunications standards to which the present invention can apply include Global System for Mobile Communications (GSM), General Packet Radio Service (GPRS), Enhanced Data rates for GSM Evolution (EDGE), Wide-band Code Division Multiple Access (WCDMA), HighSpeed Packet Access (HSPA), and Time Division Multiple Access (TDMA), such as the U.S.'s IS-136 standard. Embodiments of the present invention are expressly intended to apply to any examples discussed herein, as well as all possibilities mentioned herein.

As mentioned above, embodiments of the present invention are not limited to the part of the wireless spectrum containing the ISM band shown in FIG. 2, but may be applied to any part of the wireless spectrum where coexistence interference occurs.

Although some of the embodiments discussed herein have interfering transceivers collocated in a single device (“in-device coexistence”), embodiments of the present invention are not so limited, and also cover situations when two or more transceivers are in two or more separate devices, where their proximity and/or frequency usage is such that coexistence interference occurs. For example, the present invention would apply to the situation where two mobile terminals are close enough to cause coexistence interference between, e.g., their respective LTE and WLAN/BT transceivers. Similarly in that regard, although some embodiments herein had a WLAN/BT transceiver, those functions could be implemented in two or more transceivers, or, conversely, could be implemented in a single transceiver having one or more protocols, standards, and/or technologies in addition to WLAN/BT.

Once either coexistence interference or a specific pattern of coexistence interference is recognized pursuant to embodiments of the present invention, various remedial actions may be taken to alleviate the problem. For example, in one embodiment, adaptive filtering could be used to minimize the identified interference pattern (such as in a software radio embodiment). As another example, where WLAN/BT and LTE transceivers are suffering from coexistence interference, if the LTE transceiver is not already in DRX or HARQ process reservation mode, the system could switch over to one of those modes so that the WLAN/BT and LTE transceivers can share the airwaves. A list of non-limiting examples includes: changing the channel frequency to reduce interference, reducing the transmit power levels, changing modulation and coding schemes, reducing channel bandwidth, and autonomous denial of one of the interfering radio channels. Specific implementations of these remedial actions, and other examples of remedial actions (including, but not limited to, using a better channel filter on the interfering transmitter, implementing a time division multiplexing scheme between the two standards, using or establishing coexistence signaling to notify the victim transceiver, etc.) are well-known to those of ordinary skill in the art.

The possible solutions in other embodiments may utilize already-existing coexistence avoidance capabilities of the system. For instance, in an embodiment where one and/or both systems involved already has a coexistence function for, e.g., mitigating coexistence interference between Bluetooth and WLAN, the system could use that already-existing coexistence scheme for mitigating the detected coexistence interference between LTE and WLAN/WiFi. In this instance, if the already-existing WLAN/Bluetooth coexistence scheme involves putting the WLAN transceiver into power-save mode when Bluetooth is active, this can also be used when the LTE transceiver is active, and then the WLAN power-save mode would be disabled when the LTE transceiver is inactive, this could be used to prevent the wireless AP sending data to the WLAN transceiver when such data transmission would likely be blocked by the LTE transmission.

Advantageously, in contrast to coexistence interference solutions involving dedicated signaling, embodiments of the present invention require no extra pins for signaling on the communications processor and/or the connectivity chip in a device/system using an embodiment of the present invention. Further, the communications processor is not required to support any particular interface. This is important because the design cycle for the communications processor and/or connectivity chip is lengthy and hence it would take significant time to both standardize and implement any new signaling interface.

Further still, and in contrast to coexistence interference solutions involving predictive and/or estimation software/hardware, when a coexistence interference solution uses the above-described embodiments for detection, it will only take mitigating actions when necessary, i.e., when there actually is significant interference. Taking action only when actually necessary is advantageous in comparison to taking action based on, e.g., predictions using estimated parameters such as antenna isolation, which can vary depending on the situation of the device to other objects.

As mentioned above, embodiments of the present invention may be implemented, in whole or in part, in software, hardware, or a combination of hardware and software. In embodiments involving software, such software may comprise program instructions embodied in one or more computer-readable media, including, without limitation, Read-Only Memory (ROM), regardless of whether it is erasable or re-writable, Random Access Memory (RAM), any memory component on or accessible to an Integrated Circuit (IC) which embodies a transceiver according to an embodiment of the present invention, a memory chip, and any type of machine-recordable and machine-readable storage medium such as, for example, a Compact Disk (CD), a Digital Versatile Disk (DVD), a magnetic disk, or magnetic tape.

While several embodiments have been described, it will be understood that various modifications can be made without departing from the scope of the present invention. Thus, it will be apparent to those of ordinary skill in the art that the invention is not limited to the embodiments described, but can encompass everything covered by the appended claims and their equivalents.

What is claimed is:

1. A method of detecting coexistence interference, comprising:
receiving, by an antenna connected to a first wireless transceiver, a wireless signal, the first wireless transceiver and the connected antenna being configured to receive a first signal substantially within a first frequency band from one or more first wireless transmitters;
acquiring measurement α of a wideband signal, the wideband signal being a wired signal corresponding to the wireless signal received by the antenna;
acquiring measurement β of a narrowband signal, the narrowband signal being the result of mixing and filtering the wideband signal; and
determining, based on measurements α and β, a level of coexistence interference between the first signal and a second signal substantially within a second frequency band substantially contiguous with the first frequency band, the second signal being transmitted by one or more second wireless transmitters collocated with the first wireless transceiver.

2. The method of claim 1, wherein determining the level of coexistence interference further comprises:
determining whether the level of coexistence interference has exceeded a first predetermined threshold.

3. The method of claim 2, further comprising:
performing one or more remedial actions to avoid the coexistence interference when it is determined the level of coexistence interference has exceeded the first predetermined threshold.

4. The method of claim 1, further comprising:
tracking the level of coexistence interference over time; and
determining a pattern of coexistence interference based on the tracking of the level of coexistence interference over time.

5. The method of claim 4, wherein determining the pattern of coexistence interference based on the tracking of coexistence interference over time comprises:
determining a pattern of drift of the coexistence interference over time.

6. The method of claim 4, further comprising:
performing one or more remedial actions to mitigate the coexistence interference based on the determined pattern of coexistence interference.

7. The method of claim 1, wherein the wideband signal is the result of filtering and amplifying the received wireless signal.

8. The method of claim 1, wherein measurements α and β comprise Received Signal Strength Indicators (RSSI).

9. The method of claim 1, wherein the one or more first wireless transmitters transmit the first signal in an Industrial, Scientific, and Medical (ISM) frequency band.

10. The method of claim 1, wherein the one or more first wireless transmitters transmit the first signal in a frequency band and by a modulation in accordance with at least one of one or more Institute of Electrical and Electronic Engineers (IEEE) 802.11 standards and the Bluetooth standard.

11. The method of claim 1, wherein the one or more second wireless transmitters transmit the second signal in a frequency band and by a modulation in accordance with at least one of a Long Term Evolution (LTE), a Global System for Mobile Communications (GSM), General Packet Radio Service (GPRS), Enhanced Data rates for GSM Evolution (EDGE), Wide-band Code Division Multiple Access (WCDMA), High Speed Packet Access (HSPA), and Time Division Multiple Access (TDMA) standard.

12. The method of claim 1, wherein the first wireless transceiver has two or more antennae connected thereto configured to receive the first signal substantially within the first frequency band from the one or more first wireless transmitters, and wherein the first signal is transmitted as a multiple input, multiple output (MIMO) signal.

13. The method of claim 1, wherein the first wireless transceiver comprises two or more first wireless transceivers configured to receive the first signal as a wideband signal, and wherein the steps of acquiring measurements α and β are performed in each reception chain of the two or more first wireless transceivers.

14. A wireless transceiver, comprising:
one or more processors; and
at least one non-transitory computer-readable medium having program instructions recorded thereon, the program instructions configured to have a system comprising the wireless transceiver perform the steps of:
generating a wideband signal from a wireless signal received by an antenna connected to the wireless transceiver, wherein the wireless transceiver and the connected antenna are configured to receive a first signal substantially within a first frequency band from one or more first wireless transmitters;
acquiring measurement α of the wideband signal;
acquiring measurement β of a narrowband signal, the narrowband signal being the result of mixing and filtering the wideband signal; and
determining, based on measurements α and β, a level of coexistence interference between the first signal and a second signal substantially within a second frequency band substantially contiguous with the first frequency band, the second signal being transmitted by one or more second wireless transmitters collocated with the wireless transceiver.

15. The wireless transceiver of claim 14, wherein the program instructions are further configured to have the system comprising the wireless transceiver perform the step of:
determining whether the level of coexistence interference has exceeded a first predetermined threshold.

16. The wireless transceiver of claim 14, wherein the program instructions are further configured to have the system comprising the wireless transceiver perform the steps of:
tracking the level of coexistence interference over time; and
determining a pattern of coexistence interference based on the tracking of the level of coexistence interference over time.

17. The wireless transceiver of claim 16, wherein the program instructions configured to have the system comprising the wireless transceiver perform the step of determining a pattern of coexistence interference comprises program instructions configured to have the system comprising the wireless transceiver perform the step of:
determining a pattern of drift of the coexistence interference over time.

18. The wireless transceiver of claim 14, wherein the program instructions are further configured to have the system comprising the transceiver perform the step of:
taking one or more remedial actions to avoid coexistence interference once a predetermined criteria regarding the level of coexistence interference is met.

19. The wireless transceiver of claim 14, wherein the wireless transceiver has two or more antennae connected thereto configured to receive the first signal substantially within the first frequency band from the one or more first wireless transmitters, and wherein the first signal is transmitted as a multiple input, multiple output (MIMO) signal.

20. The wireless transceiver of claim 14, wherein the wireless transceiver comprises one of two or more wireless transceivers configured to receive the first signal as a wideband signal, and wherein the steps of acquiring measurements α and β are performed in each reception chain of the two or more wireless transceivers.

21. A wireless transceiver, comprising:
a detector configured to receive measurement α of a wideband signal and measurement β of a narrowband signal and to output a detection signal, the wideband signal being generated from a wireless signal received by an antenna connected to the wireless transceiver, wherein the wireless transceiver and the connected antenna are configured to receive a first signal substantially within a first frequency band from one or more first wireless transmitters, the narrowband signal being the result of mixing and filtering the wideband signal; and
an analyzer configured to determine, based on the detection signal, a level of coexistence interference between the first signal and a second signal substantially within a second frequency band substantially contiguous with the first frequency band, the second signal being transmitted by one or more second wireless transmitters collocated with the wireless transceiver.

22. The wireless transceiver of claim 21, wherein a system comprising the wireless transceiver is configured to determine whether the level of coexistence interference has exceeded a first predetermined threshold.

23. The wireless transceiver of claim 21, wherein a system comprising the wireless transceiver is configured to track the level of coexistence interference over time, and configured to determine a pattern of coexistence interference based on the tracking of the level of coexistence interference over time.

24. The wireless transceiver of claim 21, wherein a system comprising the wireless transceiver is configured to take one or more remedial actions to avoid coexistence interference once a predetermined criteria regarding the level of coexistence interference is met.

25. A method of detecting coexistence interference, comprising:
receiving, by an antenna connected to a first wireless transceiver, a wireless signal, the first wireless transceiver and the connected antenna being configured to receive a first signal substantially within a first frequency band from one or more first wireless transmitters;
detecting any blocking of the received wireless signal; and
determining, based on the detected blocking of the received wireless signal, a level of coexistence interference between the first signal and a second signal substantially within a second frequency band substantially contiguous with the first frequency band, the second signal being transmitted by one or more second wireless transmitters collocated with the first wireless transceiver.

26. The method of claim 25, wherein detecting any blocking of the received wireless signal comprises:
acquiring measurement α of a wideband signal, the wideband signal being a wired signal corresponding to the received wireless signal; and
acquiring measurement β of a narrowband signal, the narrowband signal being the result of mixing and filtering the wideband signal,
wherein determining the level of coexistence interference is based on measurements α and β.
